(19) United States
(12) Patent Application Publication
(10) Pub. No.: US 2023/0197309 A1
(43) Pub. Date: Jun. 22, 2023

(54) ALUMINUM ALLOY WIRES WITH HIGH STRENGTH AND HIGH ELECTRICAL CONDUCTIVITY

(71) Applicants: General Cable Technologies Corporation, Highland Heights, KY (US); NanoAl, LLC, Skokie, IL (US)

(72) Inventors: Shenjia Zhang, Zionsville, IN (US); Richard Stephen Baker, Cumming, GA (US); Janusz Stanislaw Sekunda, Williamsport, PA (US); Nhon Q. Vo, Winchester, MA (US); Francisco U. Flores, Waltham, MA (US)

(21) Appl. No.: 18/152,490

(22) Filed: Jan. 10, 2023

Related U.S. Application Data
(62) Division of application No. 16/409,569, filed on May 10, 2019, now abandoned.

(51) Int. Cl. H01B 1/02; C22C 21/02; C22C 21/08; C22F 1/047; C22F 1/05; H01B 5/10

(52) U.S. Cl. CPC H01B 1/023; C22C 21/02; C22C 21/08; C22F 1/05; C22F 1/047; H01B 5/104

(57) ABSTRACT

Aluminum alloy wires with improved electrical conductivity and improved ultimate tensile strength are disclosed. The aluminum alloys include magnesium, silicon, and copper and are formed without a solution heat treatment. The aluminum alloy wires are useful as conductors for overhead transmission lines. Methods of making the aluminum alloy wires are further disclosed.

### REFERENCE TO RELATED APPLICATION

The present application claims the priority of U.S. Application Serial No. 16/409,569, entitled ALUMINUM ALLOY WIRES WITH HIGH STRENGTH AND HIGH ELECTRICAL CONDUCTIVITY, filed May 10, 2019, and hereby incorporates the same application herein by reference in its entirety.

### GOVERNMENT LICENSE RIGHTS

This invention was made with government support under Federal Award No. DE-SC0015232, awarded by the U.S. Department of Energy. The government has certain rights in the invention.

### TECHNICAL FIELD

The present disclosure generally relates to aluminum alloy wires exhibiting high strength and high electrical conductivity. The present disclosure further relates to conductors for overhead transmission lines formed of such aluminum alloy wires.

### BACKGROUND

Overhead transmission lines are useful to conduct electrical power over large distances and are formed of air-suspended conductors. The metals used to form the conductors for the overhead transmission lines are required to balance multiple properties. For example, such metals must exhibit high electrical conductivity to maximize the ampacity of the transmission line and to minimize losses to electrical resistance and ohmic heating. The metals must also exhibit high strength to allow the conductors to span large distances between adjacent overhead transmission line towers. Conventionally, such conductors are formed of aluminum alloy.

EP Patent App. Pub. No. 3375899 A1 describes an aluminum alloy material including: zinc whose mass percentage is from 4.5% to 12.0%, magnesium whose mass percentage is from 0.7% to 3.0%, copper whose mass percentage is less than or equal to 0.6%, titanium whose mass percentage is from 0.001% to 0.5%, boron whose mass percentage is from 0.00011% to 0.2%, manganese whose mass percentage is less than or equal to 0.01%, chromium whose mass percentage is less than or equal to 0.2%, zirconium whose mass percentage is less than or equal to 0.2%, silicon whose mass percentage is less than or equal to 0.3%, iron whose mass percentage is less than or equal to 0.3%, aluminum, and other inevitable impurities.

U.S. Pat. No. 3,418,177 describes a process for preparing aluminum base alloys in wrought form, especially conductors, wherein the alloy contains magnesium and silicon including the steps of holding at an elevated temperature, hot rolling with a cooling rate during hot rolling of greater than 100° F. per minute and cooling to below 250° F. at a rater greater than 100° F. per minute with less than 20 seconds delay between said cooling and said hot rolling.

U.S. Pat. No. 3,842,185 describes an aluminum alloy conductor wire consists of between 98.0 and 99.5 weight percent aluminum, between 0.3 and 1.0 (preferably 0.4 to 0.6) weight percent iron, between 0.08 and 1.0 (preferably 0.2 to 0.4) weight percent copper, a maximum of 0.15 (preferably 0.05 to 0.08) weight percent silicon, and trace quantities of conventional impurities. The conductor wire is especially suitable for use as a conductor of a telecommunication cable or as a component element of an overhead electric conductor.

U.S. Pat. No. 9,564,254 describes an aluminum (Al) alloy wire, which is an extra fine wire having a wire diameter of 0.5 mm or less, contains, in mass %, Mg at 0.03% to 1.5%, Si at 0.02% to 2.0%, at least one element selected from Cu, Fe, Cr, Mn and Zr at a total of 0.1% to 1.0% and the balance being Al and impurities, and has an electrical conductivity of 40% IACS or more, a tensile strength of 150 MPa or more, and an elongation of 5% or more. By producing the extra fine wire from an Al alloy of a specific composition containing Zr, Mn and other specific elements, though the extra fine wire is extra fine, it has a fine structure with a maximum grain size of 50 µm or less and is superior in elongation.

### SUMMARY

In accordance with one embodiment, an aluminum alloy wire includes about 0.6% to about 0.9%, by weight magnesium, about 0.5% to about 0.9%, by weight, silicon, about 0.05% to about 1.0%, by weight, copper, and the balance is aluminum. The aluminum alloy includes elongated Mg₂Si eutectics.

In accordance with another embodiment, a process of forming an aluminum alloy wire includes forming an aluminum alloy rod and performing a T8 heat treatment or a T9 heat treatment on the aluminum alloy rod to form an aluminum alloy wire in accordance to American National Standard Institute (“ANSI”) Alloy and Temper Designation System for Aluminum H35.1 and H35.1 M (2017). The aluminum alloy includes about 0.6% to about 0.9%, by weight magnesium, about 0.5% to about 0.9%, by weight, silicon, about 0.05% to about 1.0%, by weight, copper, and the balance is aluminum. No solution heat treatment is performed.

### BRIEF DESCRIPTION OF THE DRAWINGS

FIG. 1 depicts a cross-sectional view of a conductor in accordance with certain embodiments.

FIG. 2 depicts a cross-sectional view of a conductor in accordance with certain embodiments.

FIG. 3 depicts a cross-sectional view of a conductor in accordance with certain embodiments.

FIG. 4 depicts a cross-sectional view of a conductor in accordance with certain embodiments.

FIG. 5 depicts a graph illustrating the electrical conductivity and ultimate tensile strength of example aluminum alloy wires.

### DETAILED DESCRIPTION

Conductors for overhead transmission lines are typically manufactured with aluminum, or an aluminum alloy, as a consequence of the benefits associated with aluminum’s weight, strength, conductivity, and cost compared to other metals such as copper. The formation of aluminum alloys which exhibit improved electrical conductivity and improved strength have been presently discovered. The increase in electrical conductivity and strength make the improved aluminum alloys particularly suitable for overhead transmission line conductors.

Generally, the improved aluminum alloys described herein are wrought heat treatable aluminum alloys including optimized amounts of magnesium, silicon, and copper. Advantageously, the improved aluminum alloys can be formed without a solution heat treatment.

Specifically, it has been discovered that improved aluminum alloys including, by weight, about 0.6% to about 0.9% magnesium, about 0.5% to about 0.9% silicon, and about 0.05% to about 1.0% copper can be used to form aluminum alloy wires which exhibit improved electrical conductivity and increased ultimate tensile strength when processed using an appropriate heat treatment.

As can be appreciated, the improved aluminum alloys can include any amounts of magnesium, silicon, and copper between the described ranges. For example, in certain embodiments, the improved aluminum alloys can include about 0.6% to about 0.8%, by weight, magnesium or about 0.65% to about 0.70% magnesium. In certain embodiments, the improved aluminum alloys can include about 0.50% to about 0.70%, by weight, silicon, or about 0.50% to about 0.60%, by weight silicon. In certain embodiments, the improved aluminum alloys described herein can include, by weight, about 0.05% to about 1% copper including quantities between about 0.05% and 1% copper such as 0.05% to about 0.5% copper, and about 0.05% to about 0.10% copper.

Alloys having higher loading levels of copper, such as about 0.05% or more, by weight, copper have been unexpectedly found to facilitate an increase in electrical conductivity and mechanical strength of the aluminum alloys described herein when processed with an appropriate heat treatment. It is believed that small additions of copper can modify the precipitation kinetics of the Mg₂Si phase, thus allowing for such desirable improvements.

As can be appreciated, such loading quantities of magnesium, silicon, and copper can be advantageous for a variety of reasons. For example, relatively low loading quantities of magnesium (e.g., about 0.6% to about 0.8%, by weight) can facilitate formation and processing of the alloy compared to similar alloys including greater quantities of magnesium. Additionally, the inclusion of the described quantities of magnesium, silicon, and copper can allow for the formation of desirable amounts of Mg₂Si eutectics and precipitates within the improved aluminum alloy.

In certain embodiments, the improved aluminum alloys described herein can further include additional elements. For example, in certain embodiments, iron can be included. Iron can be useful to provide improved tensile strength without lowering the electrical conductivity of the alloy. In such embodiments, iron can be included at about 0.01% to about 0.50%, by weight as high loading levels can impair wire drawing performance. In certain embodiments, the improved aluminum alloys can include about 0.10% to about 0.35%, by weight, iron or about 0.15% to about 0.20%, by weight, iron.

Additionally, or alternatively, inoculants and precipitate refiners can be included to further modify the improved aluminum alloy by influencing the grain characteristics and precipitates in the aluminum matrix. In such embodiments, the inoculants and precipitate refiners can generally be selected from metalloid elements such as one or more of tin, bismuth, strontium, indium, lead, and antimony.

As can be appreciated, a number of aluminum alloy grades have been standardized by the Accrediting Standards Committee H35 of the Aluminum Association. Standardized aluminum grades are defined by their elemental compositions with the various grades generally intended for specific applications and industries. Specific aluminum-magnesium alloys of interest were published by the Aluminum Association in January 2015 in the “International Alloy Designations and Chemical Composition Limits for Wrought Aluminum and Wrought Aluminum Alloys” including 6000-series aluminum alloys.

In certain embodiments, the improved aluminum alloys described herein can be formed by modification of known 6000-series aluminum alloys including, for example, AA6101 and AA6201 aluminum alloys.

AA6201 aluminum alloys are defined by unified number system (“UNS”) AA6201 standard and include, by weight, 0.6% to 0.9% magnesium, 0.50% to 0.90% silicon, 0.50% or less iron, 0.10% or less copper, 0.03% or less manganese, 0.03% or less chromium, 0.10% or less zinc, 0.06% or less boron, and 0.03% or less of each other element with a total of less than 0.10% of each other element, and the remainder aluminum.

As can be appreciated, relatively small quantities of other inadvertent elements may also be present in the improved aluminum alloys described herein due to, for example, processing and refinement impurities. Examples of such elements can include manganese, chromium, zinc, and boron. In certain embodiments, these elements can be present at the levels found in a typical AA6201 aluminum alloy. For example, manganese can be found at about 0.002%, by weight; chromium can be found at about 0.003%, by weight; zinc can be found at about 0.002% by weight; and boron can be found at 0.005%, by weight, in various embodiments.

In certain embodiments, any elements other than aluminum, magnesium, silicon, iron, copper, manganese, chromium, zinc, and boron can each be included at about 0.03%, by weight, or less with all such elements collectively included at about 0.10%, by weight, or less.

Wires formed from the aluminum alloys described herein have been advantageously discovered to exhibit improved electrical conductivity and ultimate tensile strength without requiring a solution heat treatment. Prior to the present discovery, it was believed that solution heat treatment would be necessary to improve the electrical conductivity and ultimate tensile strength of a conventional aluminum wire including the present quantities of magnesium and silicon (e.g., about 0.6% to about 0.8%, by weight, magnesium and about 0.50% to about 0.70%, by weight, silicon).

As can be appreciated, a solution heat treatment can be undesirable due to the considerable energy and special heat treatment equipment required by such processes. Instead, the improved aluminum alloys can be formed using a T8 heat treatment, a hot coiling treatment followed by a subsequent T8 heat treatment, or a T9 heat treatment. All heat treatment processes conform to American National Standard Institute (“ANSI”) Alloy and Temper Designation System for Aluminum standard ANSI H35.1 and H35.1 M (2017).

As used herein, a “T8 heat treatment” generally refers to a process which includes the steps of cold wire drawing an aluminum rod, and then artificially aging the drawn wire at a temperature of about 150° C. to about 190° C. for about 2 to about 24 hours, to improve ultimate tensile strength and electrical conductivity. Aluminum alloys processed with a T8 heat treatment can exhibit equiaxed crystal grains having aspect ratios of about 5 or less.

As used herein, aspect ratios can be determined as known in the art by using, for example, optical microscopy or electron microscopy and measuring the diameter and length of the crystal grains.

In certain embodiments, a T8 process can be preceded by a hot coiling process. Generally, in such processes, a hot rolled aluminum alloy is quenched in a controlled process to a temperature between 170° C. to 250° C. and then, while maintaining this temperature, wound directly and without interruption onto a winding form (e.g., a mandrel). The coiled rod is then allowed to cool either in air or a heated environment, such as a furnace, before the T8 heat treatment (e.g., cold wire drawing followed by artificial aging at 150° C. to 190° C.) is performed.

As used herein, a “T9 heat treatment” generally refers to a process in which an aluminum rod is artificially aged at a temperature of about 180° C. to about 250° C. before being drawn to a wire. In certain embodiments, the T9 heat treatment can be performed for about 16 to about 24 hours. The drawn wire is not aged at elevated temperatures. Aluminum alloys processed with a T9 heat treatment exhibit elongated grains having an aspect ratio of about 10 or greater.

As used herein, a solution heat treatment generally refers to process performed on an aluminum rod before any wiring drawing in a T8 process, any artificial aging in a T9 process, or any hot coiling. In a solution heat treatment process, an aluminum rod is heated to, and held, at a temperature of 500° C. to 600° C. for 30 minutes to 4 hours and then rapidly cooled to a temperature of less than 130° C.

As can be appreciated, in a solution heat treatment process, Mg₂Si eutectics and other precipitates are dissolved at a desired elevated temperature and remain supersaturated in the aluminum matrix after the rapid cooling. Other changes can also occur. Aluminum grain growth is also observed. The absence of elongated Mg₂Si eutectics and other precipitates indicates that a solution heat treatment was performed as these changes to the aluminum matrix will remain even after subsequent processing with a T8 heat treatment, a T9 heat treatment, or a hot coiling process.

In certain embodiments, the improved aluminum alloys described herein can retain elongated Mg₂Si eutectics as the alloys are processed only with a T8 heat treatment, a T9 heat treatment, and hot coiling. As used herein, an elongated eutectic or precipitate can refer to an eutectic or precipitate having an aspect ratio of greater than 1. As can be appreciated, these features are normally destroyed by solution heat treatment which would dissolve the Mg₂Si eutectics and other precipitates and lower the aspect ratio to about 1.

The improved aluminum alloys can exhibit improved electrical conductivity and ultimate tensile strength when compared to known AA6201 aluminum alloys. For example, the improved aluminum alloys can exhibit an increase in electrical conductivity of about 2.5% IACS in certain embodiments. As used herein, conductivity is measured by comparing the conductivity of the improved aluminum alloy to the conductivity of copper using the International Annealed Copper Standard (“IACS”). The IACS value for copper conductivity was adopted by the International Electrotechnical Commission (“IEC”) in 1913 and are defined as 1/58 Ω•mm²/m at 20° C. for 100% IACS conductivity. In certain embodiments, wires formed from the improved aluminum alloys described herein can exhibit an electrical conductivity of about 54.5% IACS to about 60% IACS. In certain embodiments, such wires can exhibit an electrical conductivity of about 55.0% IACS to about 59.5% IACS, an electrical conductivity of about 55.5% IACS to about 58% IACS, or about 56.0% to about 57.0% IACS.

In certain embodiments, wires formed from the improved aluminum alloys described herein can exhibit an ultimate tensile strength of about 250 MPa or greater, an ultimate tensile strength of about 275 MPa or greater, an ultimate tensile strength of about 300 MPa or greater, or an ultimate tensile strength of about 330 MPa or greater.

Wires formed from the improved aluminum alloys can exhibit a combination of both high electrical conductivity and high ultimate tensile strength. For example, in certain embodiments, the wires can exhibit an electrical conductivity of about 54.5% IACS to about 60% IACS and an ultimate tensile strength of about 250 MPa or greater. As can be appreciated, the electrical conductivity and the ultimate tensile strength of a wire can be related with improvements to one property diminishing the other. In certain embodiments, a wire formed from an improved aluminum alloy described herein can be optimized for both electrical conductivity and ultimate tensile strength.

In certain embodiments, the improved aluminum alloys described herein can meet or exceed the requirements of ASTM International B398 AA6201-T81 (2015) or AA6201-T83 (2015). In certain embodiments, the improved aluminum alloys described herein can also, or additionally, meet or exceed the requirements of EN 50183 A12, A13, A14, A15, A16, A17, or A18 as published by the European Committee for Electrotechnical Standardization (hereinafter, “CENELEC”) in January of 2000. As can be appreciated, meeting, or exceeding, the requirements of A14, A16, A17, or A18 was previously thought to require a solution heat treatment.

As can be appreciated, the characteristics of the improved aluminum alloys described herein can confer multiple advantages when used as a conductor for an overhead transmission line. For example, the increased conductivity can allow for increased transmission line ampacity without increasing the size or weight of the conductors. Additionally, the increase in ultimate tensile strength can allow conductors to span greater distances between support towers and operate at higher temperatures due to decreased sag.

As can be appreciated, the improved aluminum alloys described herein can be formed into overhead conductors having a variety of configurations including aluminum conductor steel reinforced (“ACSR”) cables, aluminum conductor steel supported (“ACSS”) cables, aluminum conductor composite core (“ACCC”) cables and all aluminum alloy conductor (“AAAC”) cables. ACSR, ACSS, ACCC, and AAAC cables can be used as overhead cables for overhead distribution and transmission lines.

ACSR cables are high-strength stranded conductors and include outer conductive strands, and supportive center strands. The outer conductive strands can be formed the improved aluminum alloys described herein. The center supportive strands can be steel and can have the strength required to support the more ductile outer conductive strands. ACSR cables can have high tensile strength. ACSS cables are concentric-lay-stranded cables and include a central core of steel around which is stranded one, or more, layers of the improved aluminum alloy described herein.

ACCC cables, in contrast, are reinforced by a central core formed from one, or more, of carbon, glass fiber, or polymer materials. A composite core can offer a variety of advantages over an all-aluminum or steel-reinforced conventional cable as the composite core’s combination of high tensile strength and low thermal sag enables longer spans. ACCC cables can enable new lines to be built with fewer supporting structures.

AAAC cables can be formed with the improved aluminum alloys described herein. AAAC cables can have a better corrosion resistance, due to the fact that they are largely, or completely, aluminum.

FIGS. 1, 2, 3, and 4 illustrate cross-sections of various bare overhead conductors suitable for overhead transmission lines according to certain embodiments.

As depicted in FIG. 1, certain bare overhead conductors 100 can generally include a core 110 made of one or more wires, a plurality of round cross-sectional conductive wires 120 locating around core 110, and an optional coating layer 130. The coating layer 130 can be any protective coating as known in the art. The core 110 can be steel, invar steel, carbon fiber composite, or any other material that can provide strength to the conductor. The conductive wires 120 can be formed of the improved aluminum alloys described herein.

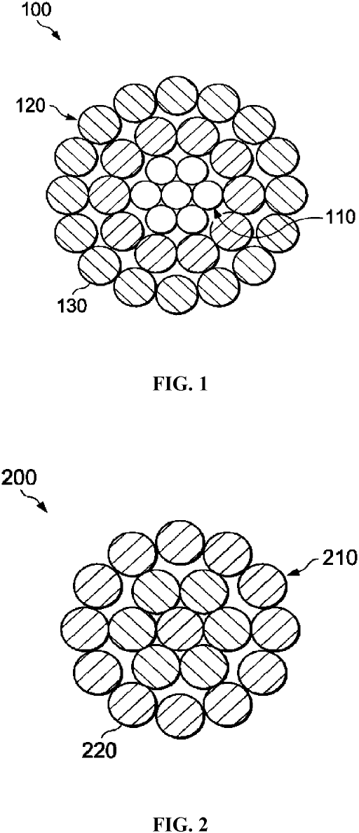

As depicted in FIG. 2, certain bare overhead conductors 200 can generally include round conductive wires 210 and an optional coating layer 220. The conductive wires 210 can be formed of the improved aluminum alloys described herein.

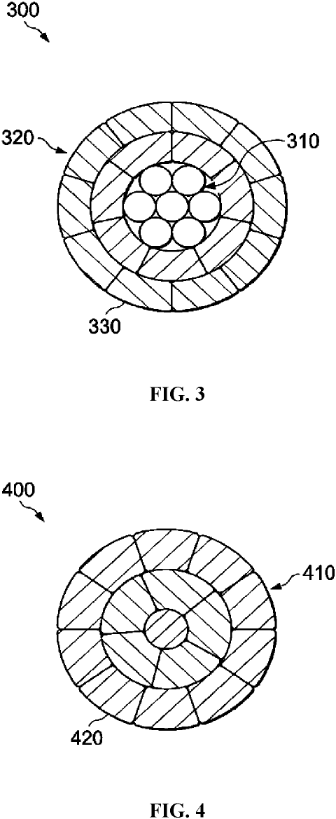

As seen in FIG. 3, certain bare overhead conductors 300 can generally include a core 310 of one or more wires, a plurality of trapezoidal-shaped conductive wires 320 around a core 310, and an optional coating layer 330. The coating layer 330 can be coated on conductive wires 320 or can be coated on only the exposed exterior portion of cable 300. The core 310 can be steel, invar steel, carbon fiber composite, or any other material providing strength to the conductor. The conductive wires 320 can be formed of the improved aluminum alloys described herein.

As depicted in FIG. 4, certain bare overhead conductors 400 can generally include trapezoidal-shaped conductive wires 410 and an optional coating layer 420. The conductive wires 410 can be formed of the improved aluminum alloys described herein.

In certain embodiments, the improved aluminum alloys described herein can alternatively be used for transmission line accessories including transformers, insulators, dead-ends / termination products, splices/joints, products, suspension and support products, motion control/vibration products “dampers”, guying products, wildlife protection and deterrent products, conductor and compression fitting repair parts, substation products, clamps and other transmission and distribution accessories. Alternatively, the improved aluminum alloys can also be used for any other known application for which a 6000-series aluminum alloy is useful for.

In certain embodiments, the elemental composition of the aluminum alloys described herein can be formed through a casting process. For example, substantially pure aluminum can be melted at a temperature of about 537° C. to 704° C. (1000° F. to about 1300° F.) and then additional elements such as magnesium, silicon, and copper can be added in accordance to their desired weight percentage. In certain embodiments, certain elements can optionally be added using a grain refiner to further control microcrystalline structure. Once all of the elements are present in accordance to their desired weight percentage, the molten aluminum mixture can be cast. Alternatively, an existing aluminum alloy can be melted and additional elements can be incorporated. In certain embodiments, a hot casting process can be used as known in the art.

As can be appreciated, many variations to the process of casting an aluminum alloy are known. For example, various stirring steps can be performed on a molten aluminum mixture to improve homogeneity. Additionally, or alternatively, a molten aluminum mixture can be allowed to settle for a period of time to allow unwanted inclusion particles to be deposited as sediment and be removed. In certain embodiment, a molten aluminum mixture can also be refined to remove impurities using, for example, alloying constituents and precise temperature control to precipitate undesired impurities out of the molten mixture.

In certain embodiments, once cast, an improved aluminum alloy can be formed by hot rolling to form a rod and then using an appropriate heat treatment on the rod. For example, the rod can then be processed using a T8 heat treatment, a hot rolling and T8 heat treatment, or a T9 heat treatment as previously described herein.

In certain embodiments, the entire process can be continuous. For example, the aluminum alloy described herein can be continuously cast, continuously hot rolled into a rod, and then continually processed using one or more of hot rolling, T8 heat treatment, and T9 heat treatment processes. Alternatively, one or more steps can be intermittent in other embodiments.

### EXAMPLES

Table 1 depicts several example wires of aluminum alloys that were formed to evaluate the effect of modifying the compositional formula of an aluminum alloy and the use of varying heat treatments. Examples 1 and 5 to 12 are comparative AA6201 aluminum alloy wires containing 0.002%, by weight, copper. Examples 1A and 1B were prepared with a T8 heat treatment. Examples 5 to 12 represent standardized wires prepared in accordance to CENELEC EN 50183 (2000) (examples 5 to 10) or ASTM B398 (2015) (examples 11 and 12). As can be appreciated, CENELEC EN 50183 Al4, Al5, and Al6 aluminum wires (examples 5, 6, and 9) require a solution heat treatment (“S”).

Examples 2 to 4 are wires formed of an aluminum alloy including 0.10%, by weight, copper. Examples 2A to 2E were prepared using a combination of hot coiling (“HC”) and a T8 heat treatment with varying aging temperatures and time (indicated in Table 1). Examples 3A and 3B were prepared using a T8 heat treatment, but without a hot coiling process, with the aging temperatures and times indicated in Table 1. Examples 4A and 4B were prepared using a T9 heat treatment with the aging temperatures and times indicated in Table 1.

Table 1 further depicts the electrical conductivity and ultimate tensile strength of each of examples 1 to 12.

TABLE 1

| Example | Composition | Heat Treatment | Aging Temp. (°C) | Aging Time (hr) | Electrical Conductivity (% IACS) | Strength (MPa) |
|---|---|---|---|---|---|---|
| 1A | AlMg_{0.65}Si_{0.50}Fe_{0.}₁₈Cu_{0.002} | T8 | 165 | 2 | 52.5 | 330 |
| 1B | AlMg_{0.65}Si_{0.50}Fe_{0.}₁₈Cu_{0.002} | T8 | 175 | 8 | 57.5 | 255 |
| 2A | AlMg_{0.64}Si_{0.58}Fe_{0.17}Cu_{0.10} | HC+T8 | 165 | 6 | 55.8 | 330 |
| 2B | AlMg_{0.64}Si_{0.58}Fe_{0.17}Cu_{0.10} | HC+T8 | 185 | 24 | 59.0 | 255 |
| 2C | AlMg_{0.64}Si_{0.58}Fe_{0.17}Cu_{0.10} | HC+T8 | 165 | 16 | 54.8 | 342 |
| 2D | AlMg_{0.64}Si_{0.58}Fe_{0.17}Cu_{0.10} | HC+T8 | 175 | 13 | 57.5 | 314 |
| 2E | AlMg_{0.64}Si_{0.58}Fe_{0.17}Cu_{0.10} | HC+T8 | 175 | 16 | 58.5 | 300 |
| 3A | AlMg_{0.64}Si_{0.58}Fe_{0.17}Cu_{0.10} | T8 | 155 | 14 | 54.9 | 330 |
| 3B | AlMg_{0.64}Si_{0.58}Fe_{0.17}Cu_{0.10} | T8 | 185 | 24 | 58.5 | 255 |
| 4A | AlMg_{0.64}Si_{0.58}Fe_{0.17}Cu_{0.10} | T9 | 200 | 16 | 56.9 | 330 |
| 4B | AlMg_{0.64}Si_{0.58}Fe_{0.17}Cu_{0.10} | T9 | 215 | 24 | 59.2 | 255 |
| 5 | Al4 | S+T8 | -- | -- | 52.9 | 342 |
| 6 | Al6 | S+T8 | -- | -- | 55.6 | 314 |
| 7 | Al2 | T8 | -- | -- | 52.5 | 325 |
| 8 | A13 | T8 | -- | -- | 52 | 295 |
| 9 | Al5 | S+T9 | -- | -- | 55.25 | 295 |
| 10 | Al7/Al8 | T8 | -- | -- | 57.5 | 300 |
| 11 | 6201-T81 | T8 | -- | -- | 52.5 | 330 |
| 12 | 6201-T83 | T8 | -- | -- | 53 | 295 |

As depicted by Table 1, inventive examples 2 to 4, representing wires formed from aluminum alloys including, by weight, 0.64% magnesium, 0.50% silicon, 0.18% iron, and 0.10% copper, exhibited desirable electrical conductivity and ultimate tensile strength when processed with a T8 or T9 heat treatment process even without the use of a solution heat treatment.

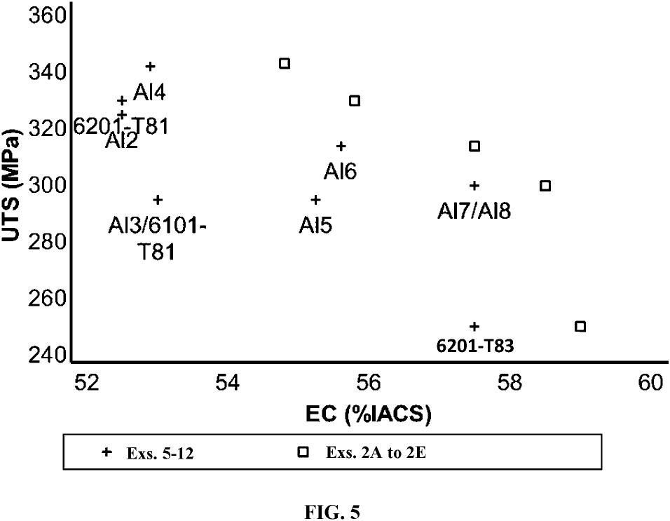

FIG. 5 depicts a graph comparing inventive examples 2A to 2E to comparative examples 5 to 12. As depicted in FIG. 5, inventive examples 2A to 2E outperformed the comparative examples by demonstrating elevated levels of electrical conductivity and ultimate tensile strength.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

1. A process of forming an aluminum alloy wire, the process comprising:
forming an aluminum alloy rod from an aluminum alloy, the aluminum alloy comprising:
about 0.6% to about 0.9%, by weight, magnesium;
about 0.5% to about 0.9%, by weight, silicon;
about 0.05% to about 1.0%, by weight, copper; and
the balance is aluminum; and
performing a T8 heat treatment or a T9 heat treatment on the aluminum alloy rod to form an aluminum alloy wire in accordance to American National Standard Institute (“ANSI”) Alloy and Temper Designation System for Aluminum H35.1 and H35.1M (2017); and
wherein no solution heat treatment is performed.

2. The process of claim 1, wherein the T8 heat treatment comprises:
cold wire drawing the aluminum alloy rod to form an unaged wire; and
artificially aging the unaged wire at a temperature of about 150° C. to about 190° C. for about 2 hours to about 24 hours.

3. The process of claim 2, further comprising the step of hot coiling the aluminum alloy rod at a temperature of about 170° C. to about 250° C.

4. The process of claim 1, wherein the T9 heat treatment comprises:
artificially aging the aluminum alloy rod at a temperature of about 180° C. to about 250° C. to form a heat treated aluminum alloy rod; and
drawing the heat treated aluminum alloy rod to form the aluminum alloy wire.

5. The process of claim 1, wherein forming the aluminum alloy rod comprises hot casting the aluminum alloy rod from a molten mixture.

6. The process of claim 1 is continuous.

7. The process of claim 1, wherein the aluminum alloy wire exhibits one or more of:
an electrical conductivity of about 52.5% to about 60%, International Annealed Copper Standard (“IACS”); and
an ultimate tensile strength (“UTS”) of about 250 MPa or greater.

8. The process of claim 1, wherein the aluminum alloy wire comprises elongated Mg₂Si eutectics.

9. The process of claim 1, wherein the aluminum alloy wire comprises about 0.05% to about 0.1%, by weight, copper.

10. The process of claim 1, wherein the aluminum alloy wire comprises about 0.01% to about 0.50%, by weight, iron.

11. The process of claim 7, wherein the aluminum alloy wire exhibits:
an electrical conductivity of about 54.5% to about 60%, pursuant to the International Annealed Copper Standard (“IACS”).

12. The process of claim 1, wherein the aluminum alloy wire exhibits:
an electrical conductivity of about 55.5% to about 60%, pursuant to the International Annealed Copper Standard (“IACS”); and
an ultimate tensile strength (“UTS”) of about 300 MPa or greater.

13. The process of claim 1, wherein the aluminum alloy wire meets or exceeds the requirements of one or more of:
ASTM International Standard B398 AA6201-T81, and AA6201-T83 (2015); and
European Committee for Electrotechnical Standardization (“CENELEC”) EN 50183 (2000) standards for one or more of A12, A13, A14, A15, A16, A17, and A18.

14. The process of claim 1, wherein forming the aluminum alloy rod comprises modifying the aluminum alloy, wherein the aluminum alloy can include 6000-series aluminum alloys.

15. The process of claim 14, wherein the 6000-series aluminum alloys are AA6101 and AA6201 aluminum alloys.

16. A process of forming an aluminum alloy wire, the process comprising:
forming an aluminum alloy rod from an aluminum alloy, the aluminum alloy comprising:
about 0.6% to about 0.9%, by weight, magnesium;
about 0.5% to about 0.9%, by weight, silicon;
about 0.05% to about 1.0%, by weight, copper; and
the balance is aluminum; and
performing a T8 heat treatment or a T9 heat treatment on the aluminum alloy rod to form an aluminum alloy wire in accordance to American National Standard Institute (“ANSI”) Alloy and Temper Designation System for Aluminum H35.1 and H35.1M (2017); and
wherein the aluminum alloy wire comprises elongated Mg₂Si eutectics; and
wherein no solution heat treatment is performed, such that the elongated Mg₂Si eutectics can be retained in the aluminum alloy wire.

17. The process of claim 16, comprising performing a T8 heat treatment, wherein the T8 heat treatment comprises:
cold wire drawing the aluminum alloy rod to form an unaged wire; and
artificially aging the unaged wire at a temperature of about 150° C. to about 190° C. for about 2 hours to about 24 hours.

18. The process of claim 17, wherein the elongated Mg₂Si eutectics have an aspect ratio of greater than 1 to about 5.

19. The process of claim 16, comprising performing a T9 heat treatment, wherein the T9 heat treatment comprises:
artificially aging the aluminum alloy rod at a temperature of about 180° C. to about 250° C. to form a heat treated aluminum alloy rod; and
drawing the heat treated aluminum alloy rod to form the aluminum alloy wire.

20. The process of claim 19, wherein the elongated Mg₂Si eutectics have an aspect ratio of about 10 or greater.
